(19) United States
(12) Patent Application Publication
(10) Pub. No.: US 2009/0248436 A1
(43) Pub. Date: Oct. 1, 2009

(54) Virtual social group management system, virtual social group management method, and computer program

(75) Inventors: Tomohiro Takagi, Kagawa (JP); Noriko Kajita, Kagawa (JP)

Correspondence Address: STAAS & HALSEY LLP, SUITE 700, 1201 NEW YORK AVENUE, N.W., WASHINGTON, DC, 20005, US

(73) Assignee: FUJITSU SHIKOKU SYSTEMS LIMITED, Kagawa (JP)

(21) Appl. No.: 12/314,089

(22) Filed: Dec. 3, 2008

(30) Foreign Application Priority Data
Mar. 31, 2008 (JP) JP2008-091761

(51) Int. Cl. G06Q 99/00; G06F 7/00; G06F 17/30; G06F 3/048

(52) U.S. Cl. 705/1; 707/103 Y; 715/771; 715/745; 707/E17.048; 707/E17.055

(57) ABSTRACT

An SNS system is provided with: a user information storage unit that stores the type of relationship for each second user who has a relationship with a first user; and a screen display control unit that causes information on each second user to be displayed in a terminal apparatus of the first user based on the type of the relationship between each second user and the first user.

### BACKGROUND OF THE INVENTION

1. Field of the Invention

The embodiments discussed herein are directed to a system, method, and the like for managing a virtual social group in a service such as an SNS.

2. Description of the Related Art

Services that allow users to communicate with one another remotely via a communication line are becoming common. Recently, users of SNSs (Social Networking Services) are increasing as well.

With an SNS, a user can exchange messages with another user, exchange opinions regarding a certain topic with multiple other users, and so on. Users with good rapport can enter into relationships called “friend” relationships and so on. By entering into such a relationship, a user can check recent information on the partner in the relationship (that is, the friend) through the user's own top page screen, easily exchange information that is to be kept hidden from users who are not friends, and so on.

Such “friend” functions have various names depending on the SNS. For example, with “mixi”, from mixi, Inc. described in mixi Complete Mastery Manual, New Revision (mixi kanzen koryaku manyuaru kaitei shinban), (Taguchi, Kazuhiro, and Ryoko Morishima, March 2007, Impress Japan; ISBN: 978-4-8443-2373-0), this function is called “my mixi”, or “my miku” for short. Meanwhile, with “MySpace”, from MySpace, Inc., this function is called “friends”.

In addition to this, some SNSs also include a service called “footprints”. With this service, when a user views the diary, profile, or the like of another user, the log of that view is recorded as a “footprint”. A user can therefore know who has viewed his/her own diary, profile, or the like.

However, the conventional “friend” functions have the following problems. Because the communities in an SNS are virtual, users can make friends much more casually than in real life. Therefore, user's friends may increase significantly if the user is not careful.

However, the more a user's number of friends increases, the more the user feels the need to act in a friend-like manner with respect to all of these friends, leading to a strong emotional burden. Furthermore, when a user's friends interact with the user him/herself very little, the user may experience apprehension that those friends do not think well of him/her.

### SUMMARY

It is an aspect of the embodiments discussed herein to provide a virtual social group management system including a portion providing a friend service and that manages a virtual social group for a first user and one or more second users to interact with one another via a communication line. The virtual social group management system includes a relationship type storage portion that stores a type of a relationship for each related user, the related user being one of the second users that has a relationship with the first user, and a display processing portion that causes information on the related users to be displayed in a terminal apparatus of the first user based on the type of the relationship for each of the related users stored in the relationship type storage portion.

Preferably, the relationship type storage portion may store at least one of a close friend type and a standard friend type as the type of the relationship for each of the related users, and the display processing portion may cause information on a related user whose relationship with the first user is of the close friend type to be displayed preferentially to information on a related user whose relationship with the first user is of the standard friend type.

Further, the virtual social group management system may be configured as follows. The virtual social group management system includes a recommended user storage portion that stores a recommended user that is one of the second users that has been recommended by a third user, a friend storage portion that stores a combination of users that have a friend relationship, and a friend registration processing portion that causes a combination of the recommended user stored in the recommended user storage portion and the first user to be stored in the friend storage portion when the first user has received an invitation from the third user and has joined the virtual social group.

According to the structure described above, it is possible for a user to use a communication means that has a “friend” service in a healthier manner than is conventionally possible.

### BRIEF DESCRIPTION OF THE DRAWINGS

FIG. 1 is a diagram illustrating an example of a network system including an SNS system and terminal apparatuses.

FIG. 2 is a diagram illustrating an example of the hardware configuration of an SNS system.

FIG. 3 is a diagram illustrating an example of the functional configuration of an SNS system.

FIG. 4 is a diagram illustrating an example of a top page screen.

FIG. 5 is a diagram illustrating an example of a personal relationship mode.

FIG. 6 is a diagram illustrating an example of group member data.

FIG. 7 is a diagram illustrating an example of recommended user data.

FIG. 8 is a diagram illustrating an example of a related user table.

FIG. 9 is a diagram illustrating an example of top display exception rule data.

FIG. 10 is a diagram illustrating an example of other screen display exception rule data.

FIG. 11 is a diagram illustrating a variation of a top page screen.

FIG. 12 is a diagram illustrating another variation of a top page screen.

FIG. 13 is a diagram illustrating an example of a message list screen.

FIG. 14 is a diagram illustrating an example of a message content screen.

FIG. 15 is a diagram illustrating a variation of a message list screen.

FIG. 16 is a diagram illustrating another variation of a message list screen.

FIG. 17 is a diagram illustrating yet another variation of a message list screen.

FIG. 18 is a diagram illustrating an example of a community screen.

FIGS. 19A and 19B are diagrams illustrating examples of the transition of personal relationship modes.

FIG. 20 is a flowchart illustrating an example of the flow of the overall processing performed by an SNS system.

FIG. 21 is a flowchart illustrating another example of the flow of the overall processing performed by an SNS system.

### DESCRIPTION OF THE PREFERRED EMBODIMENTS

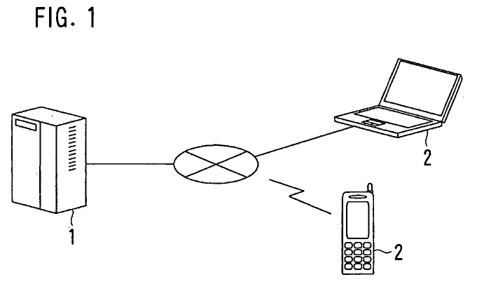

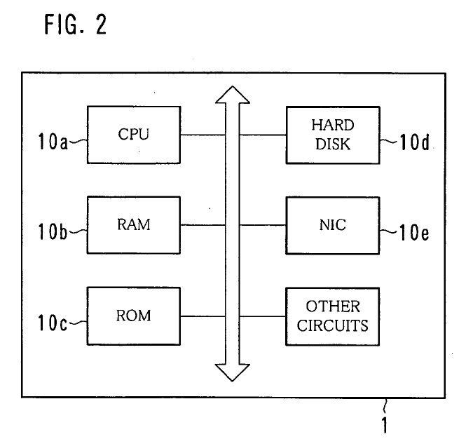

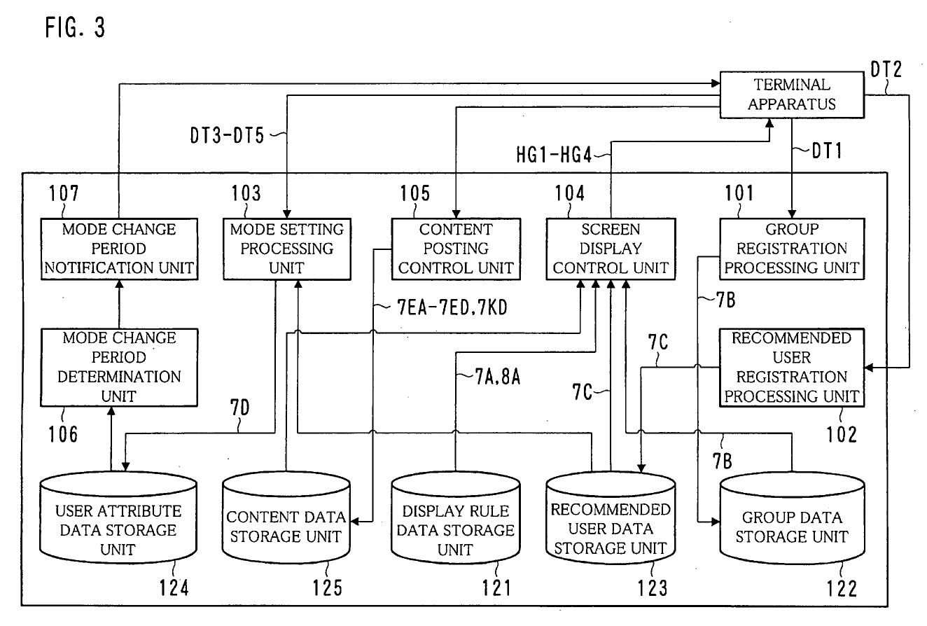

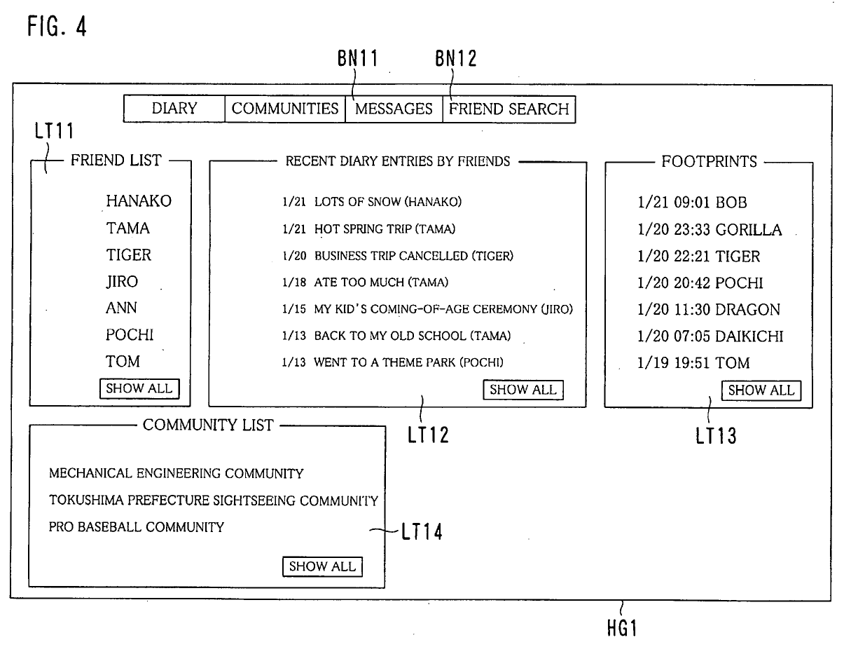

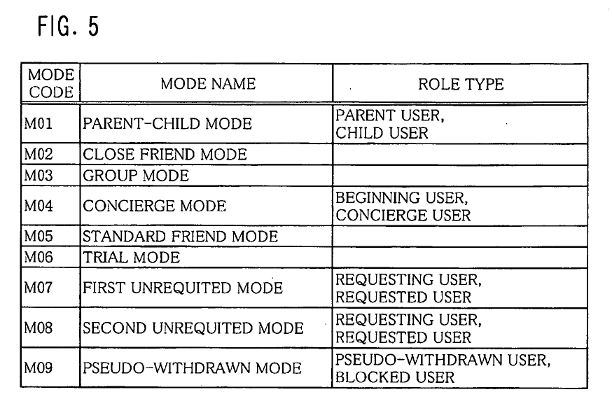

FIG. 1 is a diagram illustrating an example of a network system including an SNS system 1 and terminal apparatuses 2; FIG. 2 is a diagram illustrating an example of the hardware configuration of the SNS system 1; FIG. 3 is a diagram illustrating the functional configuration of the SNS system 1; FIG. 4 is a diagram illustrating an example of a top page screen HG1; and FIG. 5 is a diagram illustrating an example of a personal relationship mode.

In FIG. 1, the SNS system 1 is a system by which a distributor provides SNS (Social Networking Service) services, such as, for example, friends, messaging, diaries, communities, and footprints to users.

The SNS system 1 and each terminal apparatus 2 are capable of connecting to each other via a network such as the Internet.

As shown in FIG. 2, the SNS system 1 is configured of a CPU (Central Processing Unit) 10a, a RAM (Random Access Memory) 10b, a ROM (Read-Only Memory) 10c, a hard disk 10d, a NIC (Network Interface Card) 10e, and other various types of hardware.

Programs and data for implementing the functions of the following units, shown in FIG. 3, are stored in the ROM 10c or the hard disk 10d. These units include a group registration processing unit 101, a recommended user registration processing unit 102, a personal relationship setting processing unit 103, a screen display control unit 104, a content posting processing unit 105, a mode change period determination unit 106, a mode change period notification unit 107, a display rule storage unit 121, a group member storage unit 122, a recommended user storage unit 123, a user information storage unit 124, a content storage unit 125, and so on. These programs and data are loaded into the RAM 10b and executed by the CPU 10a as necessary.

A workstation, a server device, or the like is used as the SNS system 1. The SNS system 1 can also be configured with the various units shown in FIG. 3 being spread out across multiple devices.

The terminal apparatus 2 is a client by which a user uses the SNS. The terminal apparatus 2 is provided with a function for connecting to the Internet, a web browser, and an email client. A personal computer, mobile telephone terminal, or the like can be used as the terminal apparatus 2.

A user code is allocated to each user, or member, of the SNS. A user can log in to the SNS system 1 using his/her own user code and use the various abovementioned services by operating the terminal apparatus 2.

Incidentally, the roles of friends, messages, diaries, communities, and footprints are basically the same as their conventional counterparts. Furthermore, when a user logs in to the SNS system 1, a top page screen HG1 such as that shown in FIG. 4, which is a top page screen specifically for that user, is displayed in that user's terminal apparatus 2, in the same manner as is conventionally carried out.

The top page screen HG1 includes: a friend list LT11 that is a list of other users with whom the user has entered into a personal relationship, such as a friend relationship; a diary list LT12 that is a list of recent diary entries written by those other users; a footprint list LT13 that is a list of other users who have viewed the user's diary or profile (in other words, users who have left footprints on the user's page); a community list LT14 that is a list of communities in which the user participates; and so on.

However, although conventional SNSs have only the “friend” personal relationship as a personal relationship mode (category, type), the present SNS has, as shown in FIG. 5, nine personal relationship modes (called “personal relationship modes” hereinafter as well). The method of displaying information on the top page screen HG1, restrictions with regards to accessing the pages of other users, changes in personal relationships, and so on differ from the conventional system depending on the personal relationship mode of the personal relationship users have entered into with each other. Hereinafter, an outline of each personal relationship mode shall be given. The specific processing details shall be described later in order.

A “standard friend model” is a personal relationship mode for two users to enter into the personal relationship of “friend”, as per the conventional SNS system.

A “parent-child mode” is a personal relationship mode for two users to enter into a parent-child relationship. One of the users is set as the parent, and the other user is set as the child. Hereinafter, the user with the role of the parent shall be called the “parent user”, whereas the user with the role of the child shall be called the “child user”. Information indicating how the child user is using the SNS is displayed in the top page screen HG1 of the parent user so that the parent user can monitor the child user's usage.

A “close friend mode” is a personal relationship mode for two users to enter into a close friend relationship. The nickname of the other party (called a “close friend user”) is preferentially displayed in the friend list LT11, the diary list LT12, and so on of the top page screen HG1 of the two users who have entered into the close friend mode personal relationship. Furthermore, a special icon that stands out more than the icons of users in other personal relationship modes is provided on the left side of the nickname of the close friend user in each of the lists.

A “group mode” is a personal relationship mode for three or more users to enter into a friend relationship, for, for example, classmates, members of a club, and so on. Hereinafter, the other members (users) belonging to the same group aside from the primary user shall be referred to as “group friend users”. Conventionally, upon joining an SNS, a user has a personal relationship (a friend relationship in the standard friend mode in the present SNS) only with the user who invited him/her. However, in the present SNS, the inviter can invite multiple users to the SNS collectively, as a group. Then, when a person who has been invited in such a manner enters the SNS and becomes a user, that user enters into a friend relationship not only with the inviter, but also with the other users belonging to the same group (group friend users).

A “concierge mode” is a personal relationship mode for users who are unaccustomed to SNSs, such as beginners or elderly users, to enter into a relationship with users who serve as concierges, informing the unaccustomed users about the SNSs, consulting with the unaccustomed users, and so on. Hereinafter, the former shall be referred to as “beginning users”, whereas the latter shall be referred to as “concierge users”. As mentioned earlier, conventionally, upon joining an SNS, a user has a personal relationship only with the user who invited him/her. However, when a user (beginning user) enters into a personal relationship with a concierge user in the concierge mode, other users introduced by that concierge user immediately become friends with that beginning user.

A “trial mode” is a personal relationship mode for two users to enter into a conventional SNS friend relationship (a friend relationship in the standard friend mode of the present SNS) for a limited pre-set period only. When the period expires, the friend relationship between the two users is cancelled.

A “first unrequited model” and a “second unrequited mode” are both personal relationships for two users, for a user who has made a request to become friends (called a “requesting user” hereinafter) and for a user who has been thus requested (called a “requested user” hereinafter), and are personal relationship modes for a state in which the requested user has not yet accepted the request to become friends, or in other words, a state one step prior to entering into a friend relationship.

In the first unrequited mode, information on the requested user can be displayed in the friend list LT11 and diary list LT12 of the top page screen HG1 of the requesting user, but information on the requesting user is not displayed in the friend list LT11 and diary list LT12 of the top page screen HG1 of the requested user.

Meanwhile, in the second unrequited mode, information on the requesting user can be displayed in the friend list LT11 and diary list LT12 of the top page screen HG1 of the requested user, but information on the requested user is not displayed in the friend list LT11 and diary list LT12 of the top page screen HG1 of the requesting user.

A “pseudo-withdrawal model” is a personal relationship mode between two users but that is used in the case where one of the users does not wish to be viewable by the other user. When one of the users enters into a personal relationship with the other user in the pseudo-withdrawal mode, the first user appears to have withdrawn from the SNS to the other user. Hereinafter, the first user, or in other words, the user who wishes to appear to have withdrawn from the SNS, shall be referred to as a “pseudo-withdrawn user”. Meanwhile, the other user, or in other words, the user to whom it appears that the other user has withdrawn from the SNS, shall be referred to as a “blocked user”.

Note that unique mode codes are allocated to each of the abovementioned personal relationship modes, as shown in FIG. 5.

Next, the functions of the various units in the SNS system 1 shown in FIG. 3 shall be described, the descriptions being broadly divided between a function for managing personal relationships with friends and so on, a function for viewing and posting content and the like, and a function for making a notification regarding the timing of changes to personal relationships. Descriptions of points common to the functionality of a conventional SNS shall be omitted.

(Function for Managing Personal Relationships with Friends and So On)

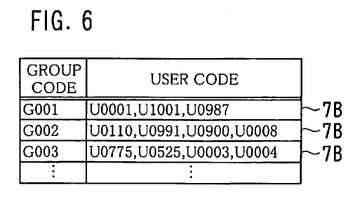

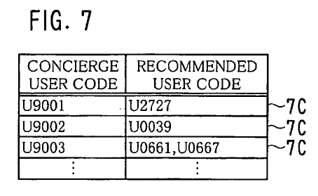

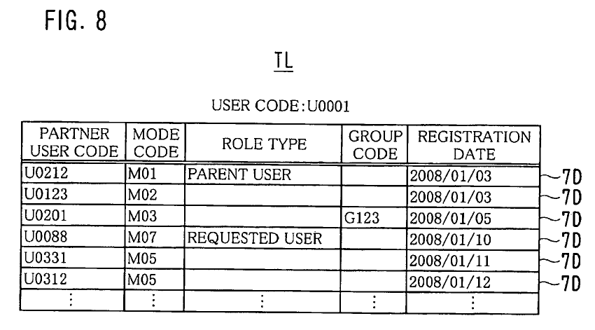

FIG. 6 is a diagram illustrating an example of group member data 7B; FIG. 7 is a diagram illustrating an example of recommended user data 7C; and FIG. 8 is a diagram illustrating an example of a related user table TL.

The group member data 7B, such as that shown in FIG. 6, is stored, on a group-by-group basis, in the group member storage unit 122 of the SNS system 1 shown in FIG. 3. The group member data 7B includes user codes for each user who is a member of the group, and a group code for distinguishing that group from other groups.

The group member data 7B is generated and stored (registered) in the group member storage unit 122 by the group registration processing unit 101 and the terminal apparatus 2 through the following procedure.

A user who wishes to form a group logs in to the SNS system 1 using his/her own user code and selects users to belong to that group by operating the terminal apparatus 2. In the case where a user who has not yet joined the SNS is selected, that user is selected by inputting his/her email address.

Upon doing so, the terminal apparatus 2 sends group creation request data DT1 indicating the user codes of the selected users or the email addresses of the users who have not yet joined the SNS system 1.

In the SNS system 1, the group registration processing unit 101 issues a new group code upon receiving the group creation request data DT1. Then, the group member data 7B, indicating the issued group code and the user codes or email addresses indicated in the received group creation request data DT1, is generated and stored in the group registration processing unit 101.

Note that the email addresses indicated in the group member data 7B are replaced by user codes issued to the owners of the addresses upon the owners of the email addresses joining the SNS.

The recommended user data 7C, as shown in FIG. 7, is stored in the recommended user storage unit 123. The recommended user data 7C includes user codes of users suitable (that is, worthy of being recommended) for a beginning user to enter into a friend relationship with (recommended user codes) and the user code of the concierge user who is the recommender (a concierge user code).

The recommended user data 7C is generated and stored (registered) in the recommended user storage unit 123 by the recommended user registration processing unit 102 and the terminal apparatus 2 through the following procedure.

A user who wishes to make a recommendation to a beginning user logs in to the SNS system 1 using his/her own user code and selects a user suitable to become friends with the beginning user by operating the terminal apparatus 2. Upon doing so, the terminal apparatus 2 sends recommendation request data DT2 indicating user codes for the selected users to the SNS system 1.

In the SNS system 1, upon receiving the recommendation request data DT2, the recommended user registration processing unit 102 generates the recommended user data 7C indicating the user code of the recommending user (the concierge user code) and the user codes indicated in the recommendation request data DT2 (recommended user codes), and stores the generated data in the recommended user registration processing unit 102.

The related user table TL, as shown in FIG. 8, is stored on a user-by-user basis in the user information storage unit 124, in association with the user code of the user.

Related user data 7D is stored in the related user table TL for each other user who has a relationship with the primary user in one of the personal relationship modes described above (called “related users” hereinafter).

In the related user data 7D, “partner user code” indicates the user code of the related user. “Mode code” indicates a mode code for the type of connection with the related user, or in other words, the personal relationship mode.

“Role type” indicates what role the related user plays in the case where the personal relationship mode is the parent-child mode, concierge mode, first unrequited mode, second unrequited mode, or pseudo-withdrawal mode. For example, in the case where the personal relationship with the related user is a personal relationship in the parent-child mode and the related user is the parent user, the “role type” in the related user data 7D of the related user is “parent user”.

In the case where the personal relationship mode is the group mode, the “group code” indicates the group code of the group into which that user was grouped by the related user.

“Registration date” indicates the date on which the user and the related user entered into the relationship. To be more specific, the “registration date” indicates the date on which the related user data 7D of the related user was stored in the user information storage unit 124.

In addition, profile data 8D, indicating a profile including the user's name, nickname, address, photo, age, sex, interests, and so on, the user's email address, the communities the user participates in, and user code, is stored in the user information storage unit 124 on a user-by-user basis.

The profile data 8D of the user is generated when the user joins the SNS system, in the same manner as the conventional SNS. The related user table TL is also generated at the same timing. Initially, when a users joins the SNS, only the related user data 7D of the inviter of that user is stored in the related user table TL. However, each time the user enters into, changes, or cancels a personal relationship with another user, the related user data 7D is newly stored, updated, or deleted.

The personal relationship setting processing unit 103 performs processing for setting personal relationships between users by generating new related user data 7D and storing the generated data in the related user table TL, updating existing related user data 7D, or deleting existing related user data 7D.

Here, the processing procedure for generating, updating, and deleting related user data 7D shall be described using a case where a user Ua joins the SNS having been invited by a user Ub and a case where the user Ua enters into a personal relationship with a user Uc after joining the SNS as examples.

### (1-1) Process for Generating Related User Data 7D

The user Ub can send an invitation to the user Ua in the conventional manner. Furthermore, in the present SNS, the user Ub can also invite the user Ua as a group member, and can also invite the user Ua as a beginning user in the concierge mode. In the case where the user Ub invites the user Ua as a group member, the group code of that group is specified in the invitation.

Upon receiving an invitation from the user Ub via an email or the like, the user Ua accesses the SNS system 1 and performs various procedures for membership, such as inputting a profile, by operating his/her own terminal apparatus 2. Through this, profile data 8D is generated for the user Ua and stored in the user information storage unit 124.

Furthermore, the personal relationship setting processing unit 103 generates a related user table TL for the user Ua, and stores the generated table in the user information storage unit 124 in association with the user code of that user. Related user data 7D is also generated for the user Ub, and stored in the related user table TL of the user Ua.

The “partner user code” in that related user data 7D indicates the user code of the user Ub. The date on which the related user data 7D was generated is indicated in the “registration date”. As a general rule, the “mode code” indicates the mode code of the standard friend mode, or “M05”.

However, in the case where the user Ua has been invited as a group member, the “mode code” indicates the mode code of the group mode, or “M03”. In addition, in this case, the “group code” indicates the group code of the group.

Meanwhile, in the case where the user Ua has been invited as a beginning user, the “mode code” indicates the mode code of the concierge mode, or “M04”. Furthermore, “role type” indicates “beginning user”.

After joining the SNS, the user Ua can enter into relationships with various users using various personal relationship modes. In the case of entering into a personal relationship with the user Uc, the user Ua logs in to the SNS system 1 using his/her own user code, specifies the user Uc, and specifies the personal relationship mode, by operating the terminal apparatus 2. When specifying the parent-child mode, concierge mode, first unrequited mode, second unrequited mode, or pseudo-withdrawal mode as the personal relationship mode, the user Ua also specifies the partner in the relationship, or in other words, the type of role the user Uc is to play (a parent user, child user, beginning user, or the like). When specifying the group mode, the user Ua also specifies the group code of the group to which s/he is to belong.

Upon doing so, the terminal apparatus 2 sends partner specification data DT3, indicating the details specified by the user Ua, to the SNS system 1.

In the SNS system 1, upon receiving the partner specification data DT3, the personal relationship setting processing unit 103 sends a message to the partner specified by the user Ua, or in other words, the user Uc, requesting the user Uc to permit the user Ua to enter into a personal relationship with the user Uc. Upon receiving a response indicating permission, new related user data 7D is generated and stored in the related user table TL of the user Ua.

The “partner user code” in that related user data 7D indicates the user code of the partner in the relationship, or in other words, the user Uc. The “mode code” and the “role type” indicate the mode code of the personal relationship mode specified by the user Ua and the type of the role played by the user Uc. In the case where the personal relationship mode is the group mode, the “group code” indicates the group code specified by the user Ua. Meanwhile, the date on which the related user data 7D was generated is indicated in the “registration date”.

However, in the case of the pseudo-withdrawal mode, new related user data 7D is generated and stored in the related user table TL of the user Ua without sending a message requesting permission and without obtaining the permission of the partner.

Meanwhile, in the case where the user Ua is a concierge user and a beginning user related to the user Ua through the concierge mode has joined the SNS, the personal relationship setting processing unit 103 generates related user data 7D for the beginning user and stores the generated data in the related user table TL of the user Ua.

It should be noted that the personal relationship setting processing unit 103 also generates and stores related user data 7D for the user Ua in the related user table TL of the user Uc. Furthermore, in the case where the user Uc is a beginning user, related user data 7D for the user Ua is also generated and stored in the related user table TL of other users introduced by the user who acts as a concierge user for the user Uc.

### (1-2) Process for Updating Related User Data 7D

A user can change relationships with related users as appropriate. As described later, a user can be notified of the timing of the change by the SNS system 1 and carry out the change at that timing, or may carry out the change at an arbitrary timing.

For example, in the case where the user Ua changes the type of his/her relationship with the user Uc, or in other words, changes the personal relationship mode, the user Ua carries out the following procedures by operating the terminal apparatus 2.

The user Ua logs in to the SNS system 1 using his/her own user code, specifies the user Uc, and specifies to what personal relationship mode to change. When changing the personal relationship mode to the parent-child mode, concierge mode, first unrequited mode, second unrequited mode, or pseudo-withdrawal mode, the user Ua also specifies the type of role the user Uc is to play (a parent user, child user, beginning user, or the like). When specifying the group mode, the user Ua also specifies the group code of the group to which s/he is to belong.

Upon doing so, the terminal apparatus 2 sends change request data DT4, indicating the details specified by the user Ua, to the SNS system 1.

In the SNS system 1, upon receiving the change request data DT4, the personal relationship setting processing unit 103 retrieves the related user data 7D of the user Uc from the related user table TL of the user Ua, and updates the related user data 7D as indicated in the change request data DT4.

### (1-3) Process for Deleting Related User Data 7D

A user can cancel relationships with related users as appropriate. For example, in the case where the user Ua cancels his/her relationship with the user Uc, the user Ua carries out the following procedures by operating the terminal apparatus 2.

The user Ua logs in to the SNS system 1 using his/her own user code, specifies the user Uc, and inputs a request to cancel the relationship.

Upon doing so, the terminal apparatus 2 sends relationship cancellation request data DT5 indicating the user Uc to the SNS system 1.

In the SNS system 1, upon receiving the relationship cancellation request data DT5, the personal relationship setting processing unit 103 retrieves the related user data 7D of the user Uc from the related user table TL of the user Ua, and deletes the retrieved data.

### (Functions for Viewing and Posting Content and So On)

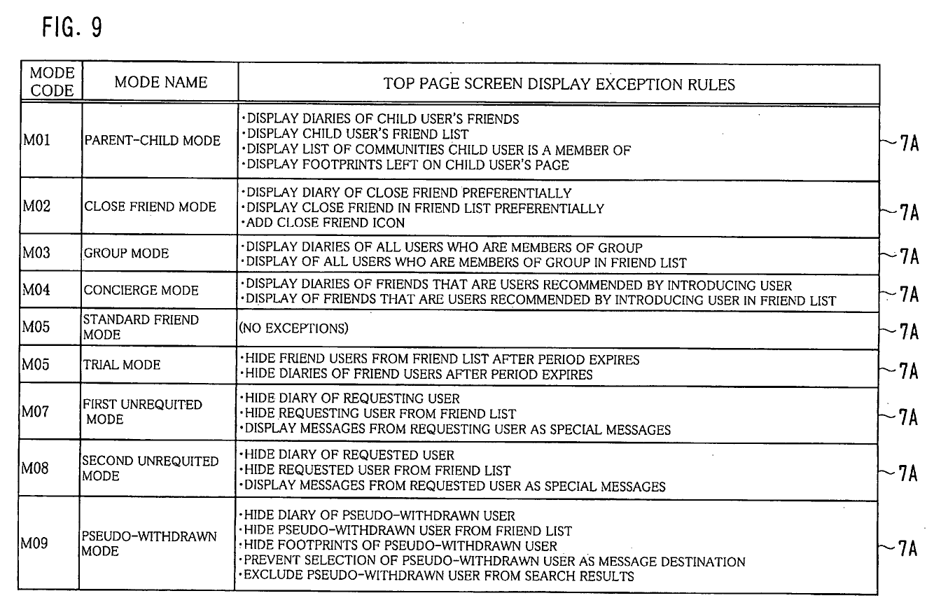

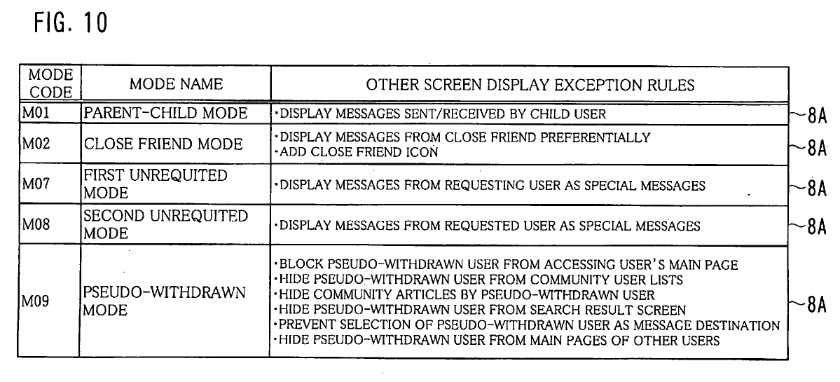

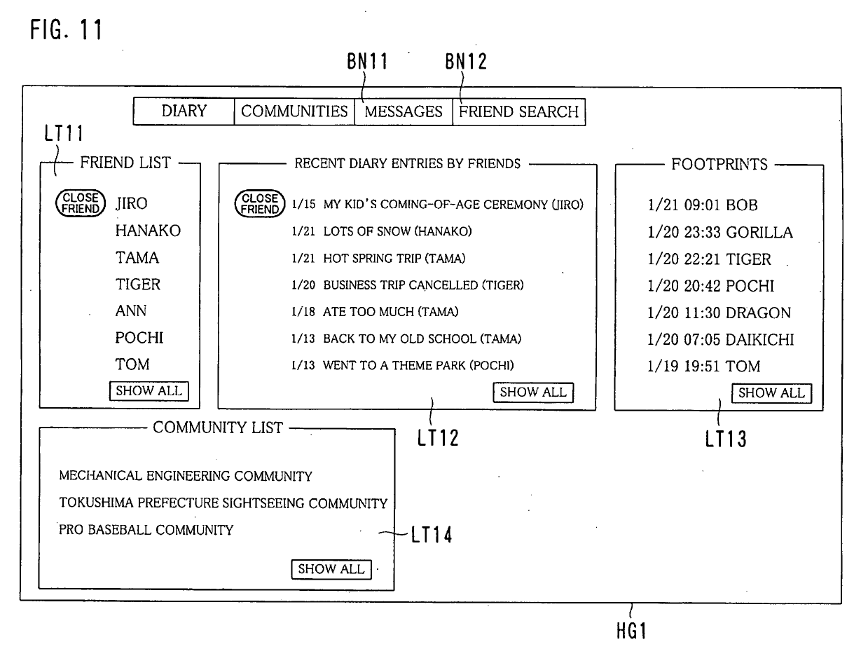

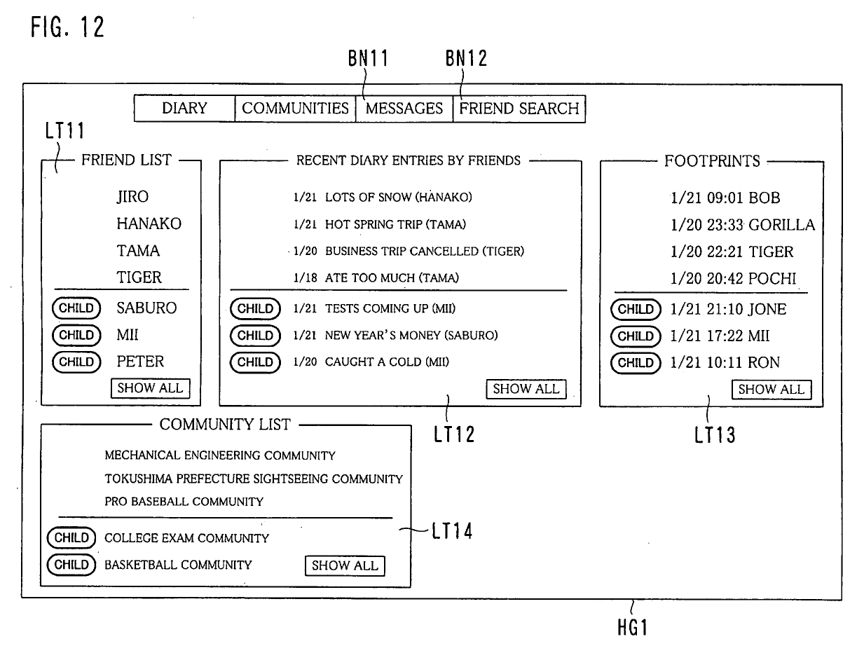

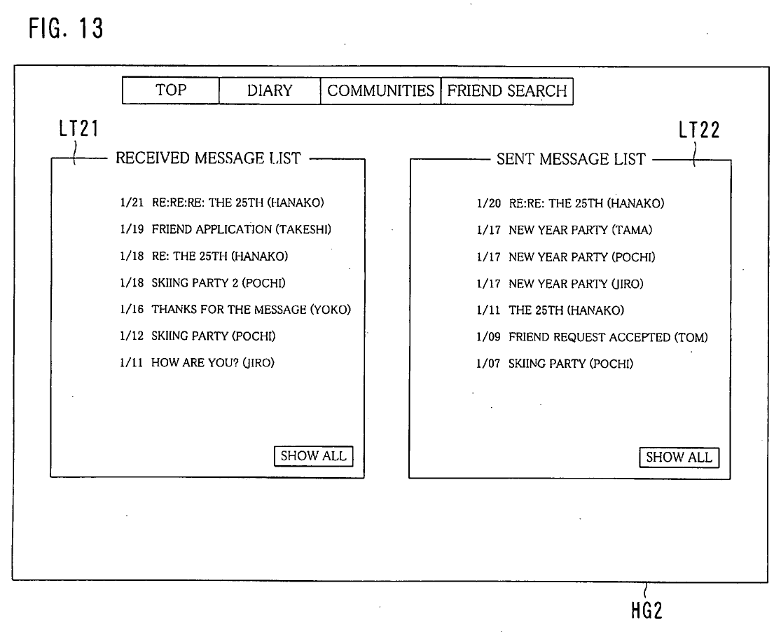

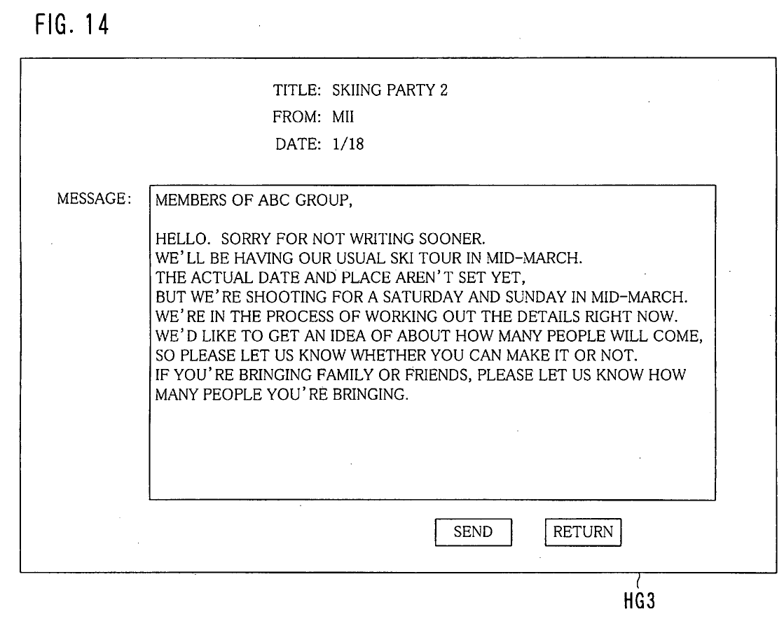

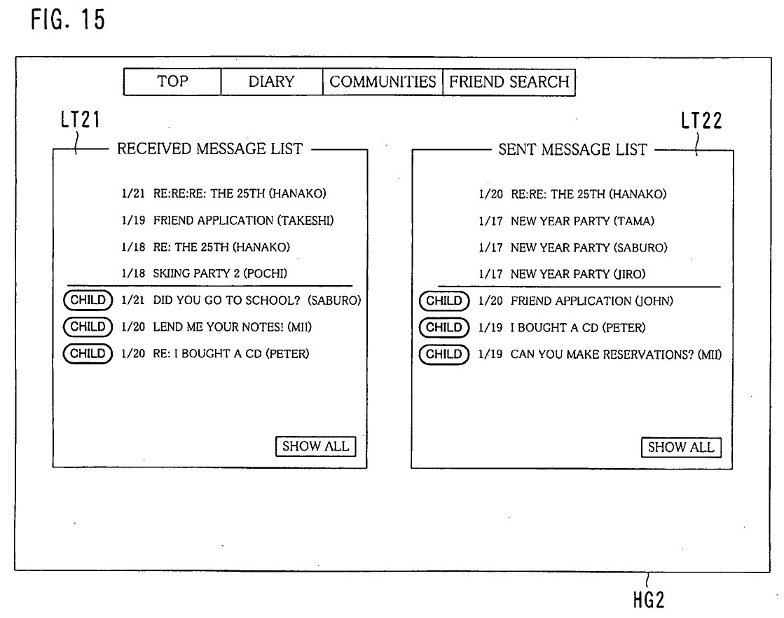

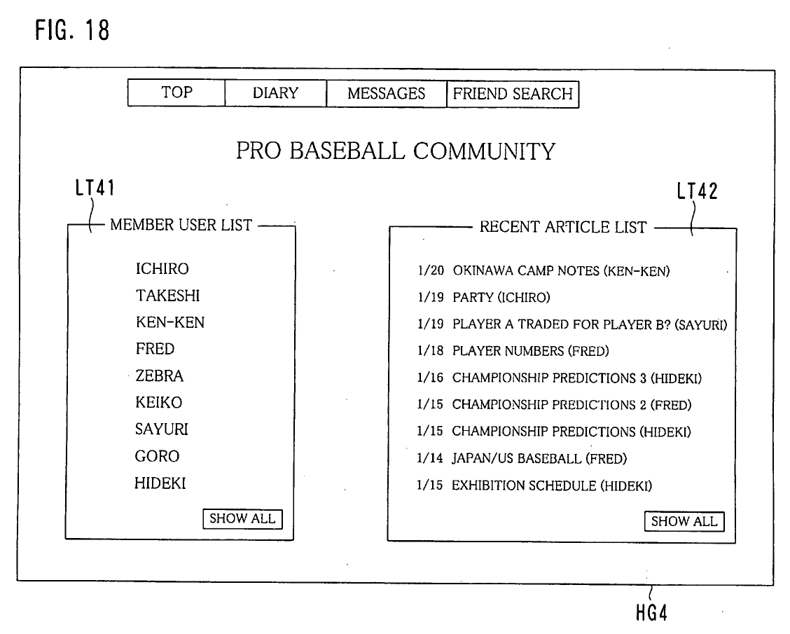

FIG. 9 is a diagram illustrating an example of top display exception rule data 7A; FIG. 10 is a diagram illustrating an example of other screen display exception rule data 8A; FIGS. 11 and 12 are diagrams illustrating variations of a top page screen HG1; FIG. 13 is a diagram illustrating an example of a message list screen HG2; FIG. 14 is a diagram illustrating an example of a message content screen HG3; FIGS. 15, 16, and 17 are diagrams illustrating variations of the message list screen HG2; and FIG. 18 is a diagram illustrating an example of a community screen HG4.

The top display exception rule data 7A, such as that shown in FIG. 9, is stored, on a personal relationship mode-by-personal relationship mode basis, in the display rule storage unit 121 of the SNS system 1 shown in FIG. 3. “Mode code” and “mode name” in the top display exception rule data 7A indicate the mode code and name, respectively, of the personal relationship mode. “Top page screen display exception rule” indicates the points in the top page screen HG1 (see FIG. 4) that differ from the friend display method in a conventional SNS. The specific format in which the top page screen HG1 is displayed based on the top display exception rule data 7A shall be described later.

Furthermore, other screen display exception rule data 8A, shown in FIG. 10, indicating the points in the screens aside from the top page screen HG1 that differ from the friend display method in a conventional SNS, is stored in the display rule storage unit 121. The specific format in which the various screens are displayed based on the other screen display exception rule data 8A shall be described later.

Data of content and the like exchanged between users is stored in the content storage unit 125. Specifically, the following types of data are stored.

The content storage unit 125 has a community database for each community. Article data 7EA, including the user code of the user who posted the article, the date/time of the post, the title of the article, and the content of the article (text data, image data, or the like) for each article posted to the community, is written into and stored in the community database of the community.

Furthermore, a diary database is provided for each user. Diary data 7EB, including the post date/time, title, and content of that diary for each diary posted by the user, is written into and stored in the diary database of that user.

Comment data 7KD that is data of comments made by other users on a user's diary is also stored in the diary database. The comment data 7KD includes the content of the comment, the date/time of that comment (comment date/time), and the user code of the commenter.

Furthermore, a message database is provided for each user. Message data 7EC, including the date/time sent, the title, and the content of the message for each message sent to the user by other users, is stored in the message database of the user.

Furthermore, a footprint database is provided for each user. Footprint data 7ED, including the user codes of other users that have left footprints on the user's page and the date/time the users left the footprints for each instance of footprints left, is written into and stored in the footprint database of that user.

The process for generating the article data 7EA, diary data 7EB, message data 7EC, and footprint data 7ED and storing these pieces of data in the content storage unit 125 is performed by the content posting processing unit 105, described later.

The screen display control unit 104 performs a process for displaying various screens in a user's terminal apparatus 2 in accordance with operations performed by the user. At this time, data for displaying those screens (HTML files, GIF files, or the like) are sent to the terminal apparatus 2.

For example, the top page screen HG1 (see FIG. 4) is displayed in the terminal apparatus 2 of a user when that user logs in to the SNS system 1. A screen showing sent or received messages is also displayed. Moreover, a screen showing user search results corresponding to conditions specified by the user is displayed. Finally, a screen showing communities specified by the user is displayed.

When displaying the abovementioned screens in the terminal apparatus 2, the screen display control unit 104 handles users having relationships that are in the standard friend mode in the same manner as in the conventional SNS system. However, there are situations where the screen display control unit 104 handles users having relationships that are in modes other than the standard friend mode in a different manner than in the conventional SNS system, based on the top display exception rule data 7A (see FIG. 9) for each personal relationship mode, stored in the display rule storage unit 121. Hereinafter, descriptions shall be given regarding how each user is handled when displaying the abovementioned screens in the terminal apparatus 2 of the user Ua.

### (2-1) Top Page Screen Display

As illustrated earlier in FIG. 4, four lists, LT11 to LT14, are arranged in the top page screen HG1 of the user Ua. Among those lists, the friend list LT11 and the diary list LT12 include the related users for the user Ua, as a general rule. The only personal relationship in the conventional SNS is the “friend” relationship, and thus all other users that are friends are displayed at once.

Furthermore, in the conventional SNS, other users who have left footprints on the page of the user him/herself are indicated in the footprint list LT13. Meanwhile, the communities of which the user him/herself is a member are indicated in the community list LT14.

However, in the present SNS, the screen display control unit 104 changes the display format in the following manner for the related users described hereinafter, based on the top display exception rule data 7A (see FIG. 9).

(2-1-1) As shown in FIG. 11, the close friend users of the user Ua are displayed in the friend list LT11 and the diary list LT12 with preference over all other users. In other words, the close friend users are displayed at the top of the friend list LT11 and the diary list LT12. Furthermore, a special icon is displayed to the left of those users' nicknames. Note that the screen display control unit 104 can determine which users are close friend users for the user Ua based on the related user table TL (see FIG. 8) of the user Ua. The personal relationship modes for the various related users, described in order hereinafter, can similarly be determined based on the related user table TL.

(2-1-2) As shown in FIG. 12, related users that are child users of the user Ua (child user friends and so on) are displayed in the friend list LT11 of the user Ua's top page screen HG1 along with the related users for the user Ua him/herself. The titles and the like of diary entries made by related users that are child users are displayed as appropriate in the diary list LT12, along with the titles and the like of diary entries made by the related users for the user Ua him/herself. Footprints left on the pages of child users are displayed in the footprint list LT13 along with footprints left on the page of the user Ua him/herself. Furthermore, the communities to which the child users belong are displayed in the community list LT14 along with the communities to which the user Ua him/herself belongs.

(2-1-3) In the case where the user Ua has been added to a group by one of the related users, the group members (in other words, the group friend users) are handled in the same manner as the related users in the standard friend mode (as “friends” in the conventional SNS). In other words, the group friend users are also displayed in the friend list LT11. Furthermore, the titles and the like of diary entries made by the group friend users are also displayed as appropriate in the diary list LT12. Note that the screen display control unit 104 can determine the members of the group based on the group member data 7B (see FIG. 6) of that group.

(2-1-4) In the case where the user Ua is a beginning user, the users recommended by the concierge user of the user Ua are handled in the same manner as related users in the standard friend mode. In other words, the recommended users are also displayed in the friend list LT11. Furthermore, the titles and the like of diary entries made by the recommended users are also displayed as appropriate in the diary list LT12. Note that the screen display control unit 104 can determine the recommended users based on the recommended user data 7C (see FIG. 7) of that concierge user.

(2-1-5) The related users of the user Ua that are in the trial mode are handled in the same manner as the related users in the standard friend mode, as a general rule. In other words, the related users in the trial mode are displayed as appropriate in the friend list LT11 and the diary list LT12. However, in the case where a predetermined period of time has already passed since the relationship with such a related user has made (that is, since the day on which the related user data 7D of the related user was registered in the related user table TL of the user Ua), that related user is displayed in neither the friend list LT11 nor the diary list LT12.

(2-1-6) A requesting user, in the first unrequited mode, of the user Ua (that is, a user who has requested to become a friend of the user Ua in the first unrequited mode) is displayed in neither the friend list LT11 nor the diary list LT12.

(2-1-7) A requested user, in the second unrequited mode, of the user Ua (that is, a user who has been requested by the user Ua to become a friend in the second unrequited mode) is displayed in neither the friend list LT11 nor the diary list LT12.

(2-1-8) A pseudo-withdrawn user, in the pseudo-withdrawal mode, of the user Ua (that is, a user who wishes to appear to the user Ua to have withdrawn) is displayed in neither the friend list LT11, the diary list LT12, nor the footprint list LT13.

### (2-2) Message Screens

When the user Ua presses a message button BN11 on the top page screen HG1, the screen display control unit 104 causes the message list screen HG2, including a received list LT21 showing a list of the titles and the like of messages sent to the user Ua and a sent list LT22 showing a list of titles and the like of message sent by the user Ua to other users, to be displayed in the terminal apparatus 2 of the user Ua. Here, as per the conventional SNS, the user Ua can cause the message content screen HG3, indicating the content (the text) of a message such as that shown in FIG. 14, to be displayed by selecting the title of that message. The screen display control unit 104 can generate these screens based on message data 7EC and the like for the user Ua stored in the content storage unit 125.

Furthermore, in the present SNS, the screen display control unit 104 changes the display format in the following manner for the related users described hereinafter, in accordance with the other screen display exception rule data 8A (see FIG. 10).

(2-2-1) As shown in FIG. 15, the titles and the like of messages sent to the child users of the user Ua are also displayed in the received list LT21 in the message list screen HG2 of the user Ua. Moreover, the titles and the like of messages sent by the child users to other users are also displayed in the sent list LT22. The user Ua can also cause the content of both the messages sent to the child users and the messages sent by the child users to be displayed in the same manner as his/her own messages, as shown in FIG. 14.

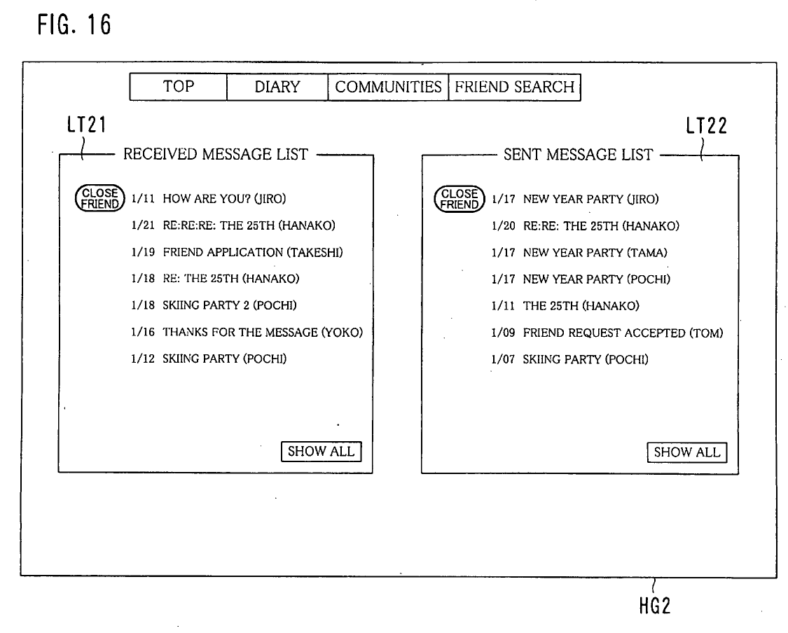

(2-2-2) As shown in FIG. 16, the titles and so on of messages from close friend users of the user Ua are displayed with preference over the titles and so on of messages from all other users. In other words, the titles of messages from close friend users are displayed at the top of the received list LT21. Furthermore, a special icon is displayed to the left of those users' nicknames.

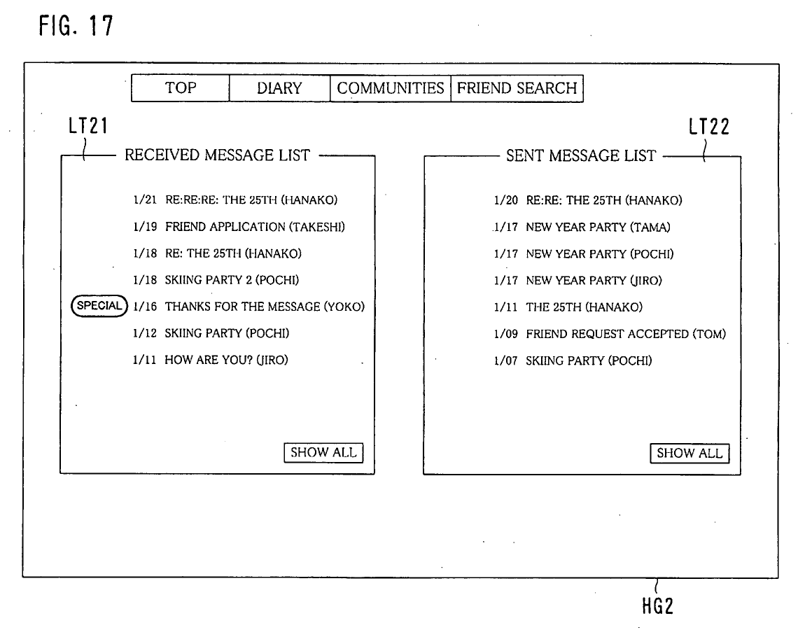

(2-2-3) An icon is displayed in order to identify messages from a requesting user, in the first unrequited mode, of the user Ua (that is, a user who has requested to become a friend of the user Ua in the first unrequited mode) as being special, as shown in FIG. 17. Similarly, an icon is displayed in order to identify messages from a requested user, in the second unrequited mode, of the user Ua (that is, a user who has been requested by the user Ua to become a friend in the second unrequited mode) as being special.

### (2-3) Search Result Screen Display

When the user Ua presses a search button BN12 on the top page screen HG1, the screen display control unit 104 causes a dialog screen for entering search keywords to be displayed in the terminal apparatus of the user Ua. The user Ua inputs a keyword related to the user s/he is searching for, and enters the search command. Upon doing so, the SNS system 1 searches for a user related to that keyword based on the profile data 8D and so on of users stored in the user information storage unit 124. The screen display control unit 104 then causes a search result screen indicating the nickname and the like of that user to be displayed in the terminal apparatus 2 of the user Ua. The method for causing the search results to be displayed is thus basically the same as in the conventional SNS system.

However, the screen display control unit 104 excludes pseudo-withdrawn users for the user Ua (that is, users who wish to appear to the user Ua to have withdrawn) from the search results, and does not display the nicknames of such pseudo-withdrawn users, in accordance with the other screen display exception rule data 8A (see FIG. 10).

### (2-4) Community Screen Display

Each time the user Ua selects a community within the community list LT14 and so on in the top page screen HG1, the screen display control unit 104 causes that community screen HG4 to be displayed in the terminal apparatus 2 of the user Ua, as shown in FIG. 18. A member list LT41 indicating a list of users who belong to that community and an article list LT42 indicating a list of posted articles are, for example, included in the community screen HG4. The method for causing the community screen to be displayed is thus basically the same as in the conventional SNS system.

However, the screen display control unit 104 does not display the pseudo-withdrawn users for the user Ua in the member list LT41, in accordance with the other screen display exception rule data 8A (see FIG. 10). Furthermore, the screen display control unit 104 does not display the articles of the pseudo-withdrawn users in the article list LT42.

As described above, the screen display control unit 104 performs a display process so that no information on pseudo-withdrawn users for the user Ua is visible to the user Ua. Accordingly, the user Ua cannot access any of a pseudo-withdrawn user's pages. The screen display control unit 104 also blocks access when the user Ua enters the URL (Uniform Resource Locator) of the pseudo-withdrawn user's page directly and attempts to access the page thereby.

The content posting processing unit 105 shown in FIG. 3 performs processes for writing various content and logs obtained as a result of user activity, such as the posting of articles to communities, the posting of diary entries, the sending of messages, and the records of footprints, into various databases in the content storage unit 125. These processes are the same as the processes executed in the conventional SNS.

As described above, the user to whom the pseudo-withdrawn user wishes to appear to have withdrawn, or in other words, the blocked user, cannot confirm the presence of the pseudo-withdrawn user, and cannot access the pages of the pseudo-withdrawn user. Therefore, the blocked user also cannot send messages to the pseudo-withdrawn user. Even if the blocked user somehow attempts to send a message to the pseudo-withdrawn user, the content posting processing unit 105 rejects and stops the process for sending the message.

### (Function for Notifying Timing of Personal Relationship Change)

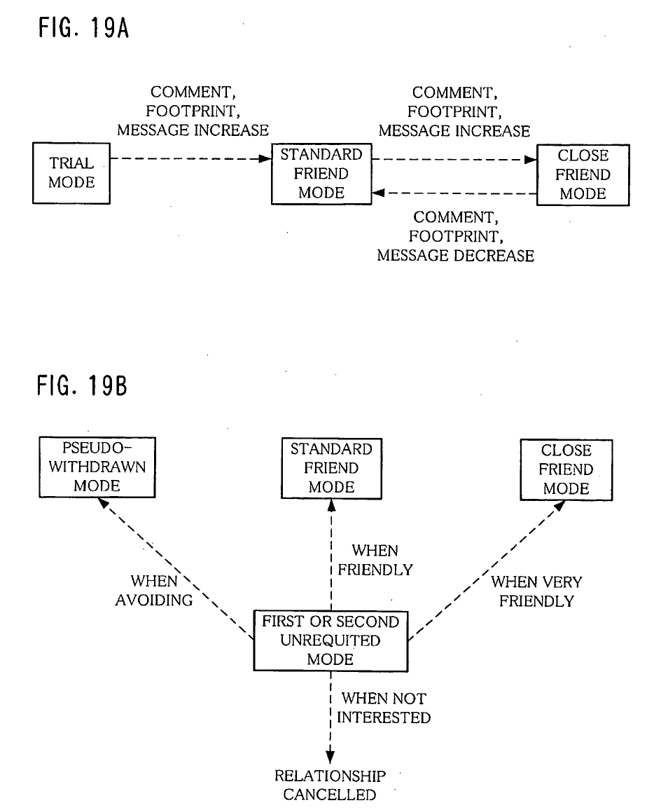

FIGS. 19A and 19B are diagrams illustrating examples of the transition of the personal relationship modes.

The mode change period determination unit 106 performs a process for determining whether or not the timing (period) for changing the personal relationship mode for a relationship between two users has arrived. This shall be described hereinafter using the case of determining whether or not the timing (period) for changing the personal relationship mode for a relationship between the users Ua and Ub has arrived as an example.

Once a predetermined period (for example, one month) has passed since the users Ua and Ub entered into a personal relationship in the trial mode, the standard friend mode, or the close friend mode, the mode change period determination unit 106 counts, periodically or upon the occurrence of an event between the two users, the number of events that occurred between the two users in the previous predetermined period (for example, one month). To be more specific, the number of times one of the users performed an action such as described below with respect to the other user is counted.

The total of the number of times the user Ua commented on the user Ub's diary and the number of times the user Ub commented on the user Ua's diary during the predetermined period (called the “comment number Km” hereinafter) is counted. In addition, the total of the number of times the user Ua left footprints on the user Ub's page and the number of times the user Ub left footprints on the user Ua's page during the predetermined period (called the “footprint number Kn” hereinafter) is counted. Furthermore, the total of the number of times the user Ua sent a message to the user Ub and the number of times the user Ub sent a message to the user Ua during the predetermined period (called the “message number Kp” hereinafter) is counted.

Then, the mode change period determination unit 106 determines whether or not it is time to change the personal relationship mode and what personal relationship mode to change to, in accordance with whether or not evaluation points Pt fulfill the following equations (1) or (2).

Pt≧α1 (1)

α1>Pt≧α2 (2)

where α1 and α2 are arbitrary positive thresholds. α1>α2; Pt=βm·Km+βn+βp·Kp; and βm, βn, and βp are arbitrary positive coefficients. For example, α1 is set to “50”, and α2 is set to “25”. In such a case, βm is set to “5”, βn to “1”, and βp to “3”.

In the case where the count results have been detected as fulfilling equation (1) or equation (2) when the personal relationship mode of the relationship between the users Ua and Ub is the trial mode, the mode change period determination unit 106 determines that it is time to change the personal relationship mode to the standard friend mode.

Meanwhile, in the case where the count results have been detected as fulfilling equation (1) during the standard friend mode, the mode change period determination unit 106 determines that it is time to change the mode to the close friend mode.

Furthermore, in the case where the count results have been detected as fulfilling neither equation (1) nor equation (2) during the close friend mode, the mode change period determination unit 106 determines that it is time to change the mode to the standard friend mode.

The mode change period notification unit 107 notifies both the users Ua and Ub of the results of the determination performed by the mode change period determination unit 106 via email or a message. The users Ua and Ub then check the determination results of which they were notified and decide whether or not to change the personal relationship mode. The users Ua and Ub then operate their terminal apparatuses 2 through the procedure described earlier to request the SNS system 1 to execute the change. The personal relationship setting processing unit 103 of the SNS system 1 then re-sets the personal relationship between the two users based on the request. Through such a process, the personal relationship between the users Ua and Ub can be shifted as shown in FIG. 19A.

Note that the personal relationship setting processing unit 103 may automatically re-set the personal relationship between the users Ua and Ub based on the results of the determination performed by the mode change period determination unit 106, regardless of the judgment of those two users.

In addition, in the case where a user is a requested user in the first unrequited mode or the second unrequited mode, the personal relationship mode of the relationship with the requesting user can be changed in accordance with the behavior of the requesting user, as shown in FIG. 19B.

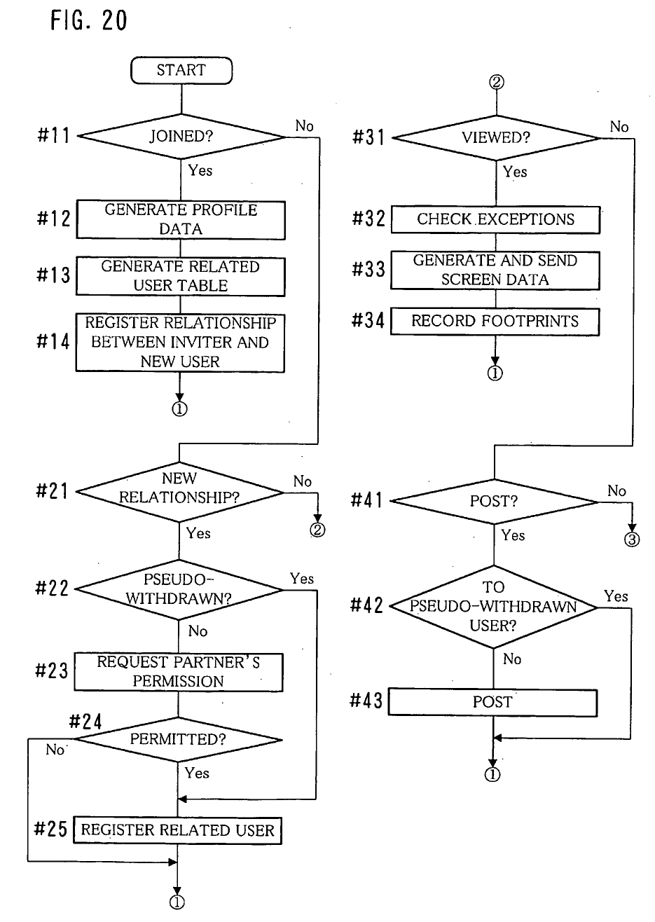

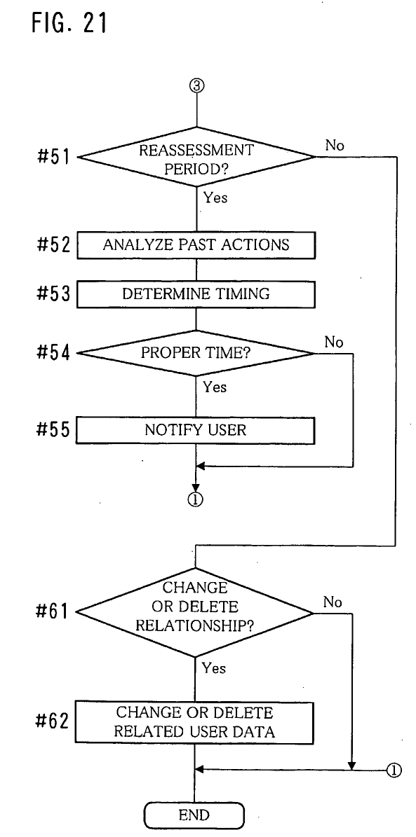

FIGS. 20 and 21 are flowcharts illustrating an example of the flow of the overall processing performed by the SNS system 1.

Next, the flow of the overall processing for managing the personal relationships between users and providing services in the SNS system 1 shall be described with reference to the flowcharts in FIGS. 20 and 21.

Each time an event occurs, the SNS system 1 executes the processes shown in FIGS. 20 and 21 in accordance with that event.

Upon a new user joining the SNS (Yes in #11 of FIG. 20), the SNS system 1 generates profile data 8D for that user (#12). The related user table TL for that user is then generated (#13). Furthermore, the related user data 7D of the inviter of that user is registered in the related user table TL of that user, and the related user data 7D of that user is registered in the related user table TL of the inviter of that user (#14). Through this, the personal relationship between that user and the inviter is set.

Moreover, upon receiving a request for registration of a new personal relationship from a user (a friend request or the like) (Yes in #21), the SNS system 1 requests permission from the partner (#23). If permission is granted (Yes in #24), the related user data 7D of the partner is registered in the related user table TL of that user, and the related user data 7D of that user is registered in the related user table TL of the partner (#25). Through this, the personal relationships of the two users are set. However, in the case where the type of the current personal relationship is the pseudo-withdrawal mode and the partner plays the role of the blocked user (Yes in #22), the registration process of Step #25 is carried out without obtaining permission from the partner.

Meanwhile, upon receiving a request to view information from a user (Yes in #31), the SNS system 1 determines information to be presented to that user in a special manner and information that is not to be presented to that user, in accordance with the top display exception rule data 7A (see FIG. 9) and the other screen display exception rule data 8A (see FIG. 10) (#32). Screen data is then generated through adding information to be presented in a special manner to the information that is conventionally presented, removing information that is not to be presented from the information that is conventionally presented, rearranging the order of related users, displaying icons next to the nicknames of close friends, and so on; the generated data is then sent to the terminal apparatus 2 of the user (#33). In the case where that user has viewed another user's page, the SNS system 1 records footprints (#34).

Meanwhile, when the user writes an entry in his/her own diary, posts an article to a community, comments on another user's diary, writes a message to another user, or the like (Yes in #41), the SNS system 1 records the written content thereof in a predetermined database (#43). However, in the case where that user has written a message to a pseudo-withdrawn user (Yes in #42), the SNS system 1 rejects the acceptance of the message.

Meanwhile, if the period for reassessing the personal relationship mode between two users has arrived (Yes in #51 of FIG. 21), the SNS system 1 analyzes the actions between the two users and calculates the evaluation points Pt (#52), and determines whether or not it is time to change the personal relationship mode and what personal relationship mode to change to based on that value (#53). Then, in the case where it is time to change the mode (Yes in #54), both users are notified of the determination results (#55).

Finally, upon receiving a request to change or cancel the personal relationship mode from a user (Yes in #61), the SNS system 1 updates the related user data 7D of the partner in the related user table TL of that user and changes the related user data 7D of that user in the related user table TL of the partner, or deletes both instances of related user data 7D, in accordance with the request (#62).

According to the present embodiment, a user can enter into a personal relationship, such as a friend relationship, from among multiple personal relationship modes, in accordance with the relationship between the user him/herself and the partner. It is therefore possible to reduce the emotional burden felt when all related users must be treated in the same manner, thereby enabling the SNS to be used in a healthier manner. This is particularly beneficial for veteran users of SNSs.

SNS beginners can find friends in a more secure manner by using the concierge mode. Furthermore, friends settings can be made with ease through the group mode.

Although icons are displayed in the top page screen HG1 for the close friend users and child users in the present embodiment, icons may also be displayed for other related users based on their personal relationship modes.

In addition, many modifications to part or all of the configuration of the SNS system 1, the processing details, the processing order, the method of selecting the information to display, the data structure, the personal relationship modes, and so on can be made without deviating from the scope of the present invention.

According to the system disclosed in the present application, a virtual social group management system that is provided with a portion providing a friend service and that manages a virtual social group for a first user and one or more second users to interact with one another via a communication line can be configured including a relationship type storage portion that stores a type of a relationship for each related user, the related user being one of the second users that has a relationship with the first user, and a display processing portion that causes information on the related users to be displayed in a terminal apparatus of the first user based on the type of the relationship for each of the related users stored in the relationship type storage portion. According to the system disclosed in the present application, the information on a related user is displayed based on the relationship type, thus making it possible to express a friend relationship in a terminal apparatus. As a result, a user can use a communication means with a friend service, such as an SNS, in a healthier manner than is conventionally possible.

Furthermore, according to the system disclosed in the present application, the abovementioned configuration can be configured so that the relationship type storage portion stores at least one of a close friend type and a standard friend type as the type of the relationship for each of the related users, and the display processing portion causes information on a related user whose relationship with the first user is of the close friend type to be displayed preferentially to information on a related user whose relationship with the first user is of the standard friend type. According to the system disclosed in the present application, the priority of display is changed based on the depth of the relationship type, thus making it possible to express the depth of a friend relationship in a terminal apparatus. As a result, a user can use a communication means with a friend service, such as an SNS, in a healthier manner than is conventionally possible.

Furthermore, according to the system disclosed in the present application, one of the above configurations of a combination of both configurations can be configured so as to further include a second display processing portion that causes information on the first user to be displayed in a terminal apparatus of the related user, wherein the relationship type storage portion stores at least one of a standard friend type and an unrequited friend type as the type of the relationship for each of the related users, the display processing portion causes information on a related user whose relationship with the first user is of the standard friend type to be displayed, but does not cause information on a related user whose relationship with the first user is of the unrequited friend type to be displayed, and the second display processing portion causes information on the first user to be displayed in the terminal apparatus of the related user regardless of whether the type of the relationship with the related user is the standard friend type or the unrequited friend type. According to the system disclosed in the present application, whether or not to display a partner in a user's terminal apparatus is switched based on whether the friend relationship between the users is mutual or unrequited, thus making it possible to conceal an unrequited friend relationship so that the partner is not aware of the relationship. As a result, a user can use a communication means with a friend service, such as an SNS, in a healthier manner than is conventionally possible.

Furthermore, according to the system disclosed in the present application, one of the above configurations of a combination of both configurations can be configured so as to further include a second display processing portion that causes information on the first user to be displayed in a terminal apparatus of the related user, wherein the relationship type storage portion stores at least one of a standard friend type and an unrequited friend type as the type of the relationship for each of the related users, he display processing portion causes both information on a related user whose relationship with the first user is of the standard friend type and information on a related user whose relationship with the first user is of the unrequited friend type to be displayed, and the second display processing portion causes information on the first user to be displayed in the terminal apparatus of the related user where the type of the relationship with the related user is the standard friend type, but does not cause the information on the first user to be displayed in the terminal apparatus of the related user where the type of the relationship with the related user is the unrequited friend type. According to the system disclosed in the present application, whether or not to display the information on a second user in the terminal apparatus of a first user can be selected even if the friend relationship between the users is unrequited, thus making it possible to select whether to conceal the existence of the second user or, conversely, to promote the existence of the second user. As a result, a user can use a communication means with a friend service, such as an SNS, in a healthier manner than is conventionally possible.

Furthermore, according to the system disclosed in the present application, one of the above configurations of a combination of both configurations can be configured so as to include a second display processing portion that causes information on the first user to be displayed in a terminal apparatus of the related user, wherein the relationship type storage portion stores at least one of a standard friend type and a pseudo-withdrawn type as the type of the relationship for each of the related users, and the second display processing portion causes information on the first user to be displayed in the terminal apparatus of the related user where the type of the relationship with the related user is the standard friend type, but does not cause the information on the first user to be displayed in the terminal apparatus of the related user where the type of the relationship with the related user is the pseudo-withdrawn type. According to the system disclosed in the present application, information is not displayed regardless of whether the friend relationship is direct or indirect, thus making it possible to avoid displaying information indirectly via another user after the friend relationship has been cancelled. As a result, a user can use a communication means with a friend service, such as an SNS, in a healthier manner than is conventionally possible.

Furthermore, according to the system disclosed in the present application, one of the above configurations of a combination of both configurations can be configured so that the relationship type storage portion stores at least one of a close friend type, a standard friend type, and a trial type as the type of the relationship for each of the related users, the display processing portion causes information on a related user whose relationship with the first user is of the close friend type to be displayed preferentially to information on a related user whose relationship with the first user is of the standard friend type and information on a related user whose relationship with the first user is of the trial type, and does not cause the information on the related user whose relationship with the first user is of the trial type to be displayed when a predetermined amount of time has passed since the relationship with the first user was established as the trial type, and where no less than a predetermined number of events have occurred between the first user and a related user, the relationship type storage portion changes the type of the relationship between the first user and the related user from the trial type to the standard friend type, or from the standard friend type to the close friend type, and stores that type. According to the system disclosed in the present application, the relationship type is changed to a deeper type in the case where there have been no less than a predetermined amount of events between users, thus making it possible to, for example, automatically optimize the relationship type. As a result, a user can use a communication means with a friend service, such as an SNS, in a healthier manner than is conventionally possible.

Furthermore, according to the system disclosed in the present application, one of the above configurations of a combination of both configurations can be configured so that the relationship type storage portion stores at least one of a close friend type, a standard friend type, and a trial type as the type of the relationship for each of the related users, the display processing portion causes information on a related user whose relationship with the first user is of the close friend type to be displayed preferentially to information on a related user whose relationship with the first user is of the standard friend type and information on a related user whose relationship with the first user is of the trial type, and does not cause the information on the related user whose relationship with the first user is of the trial type to be displayed when a predetermined amount of time has passed since the relationship with the first user was established as the trial type, and where less than a predetermined number of events have occurred between the first user and a related user, the relationship type storage portion changes the type of the relationship between the first user and the related user from the close friend type to the standard friend type and stores that type. According to the system disclosed in the present application, the relationship type is changed to a shallower type in the case where there have been less than a predetermined amount of events between users, thus making it possible to, for example, automatically optimize the relationship type. As a result, a user can use a communication means with a friend service, such as an SNS, in a healthier manner than is conventionally possible.

Furthermore, according to the system disclosed in the present application, a virtual social group management system that is provided with a portion providing a friend service and that manages a virtual social group for a first user and one or more second users to interact with one another via a communication line can be configured including: a recommended user storage portion that stores a recommended user that is one of the second users that has been recommended by a third user, a friend storage portion that stores a combination of users that have a friend relationship, and a friend registration processing portion that causes a combination of the recommended user stored in the recommended user storage portion and the first user to be stored in the friend storage portion when the first user has received an invitation from the third user and has joined the virtual social group. According to the system disclosed in the present application, the friend relationships are pre-set for other users aside from the friend that invited a user to the SNS, thus making it possible to, for example, eliminate the burden of setting friend relationships with members of a group aside from the friend that invited the user, even when joining the SNS as in a group. As a result, a user can use a communication means with a friend service, such as an SNS, in a healthier manner than is conventionally possible.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A virtual social group management system that is provided with a portion providing a friend service and that manages a virtual social group for a first user and one or more second users to interact with one another via a communication line, the system comprising:
a relationship type storage portion that stores a type of a relationship for each related user, the related user being one of the second users that has a relationship with the first user; and
a display processing portion that causes information on the related users to be displayed in a terminal apparatus of the first user based on the type of the relationship for each of the related users stored in the relationship type storage portion.

2. The virtual social group management system according to claim 1,
wherein the relationship type storage portion stores at least one of a close friend type and a standard friend type as the type of the relationship for each of the related users; and
the display processing portion causes information on a related user whose relationship with the first user is of the close friend type to be displayed preferentially to information on a related user whose relationship with the first user is of the standard friend type.

3. The virtual social group management system according to claim 1, further comprising:
a second display processing portion that causes information on the first user to be displayed in a terminal apparatus of the related user,
wherein the relationship type storage portion stores at least one of a standard friend type and an unrequited friend type as the type of the relationship for each of the related users;
the display processing portion causes information on a related user whose relationship with the first user is of the standard friend type to be displayed, but does not cause information on a related user whose relationship with the first user is of the unrequited friend type to be displayed; and
the second display processing portion causes information on the first user to be displayed in the terminal apparatus of the related user regardless of whether the type of the relationship with the related user is the standard friend type or the unrequited friend type.

4. The virtual social group management system according to claim 1, further comprising:
a second display processing portion that causes information on the first user to be displayed in a terminal apparatus of the related user,
wherein the relationship type storage portion stores at least one of a standard friend type and an unrequited friend type as the type of the relationship for each of the related users;
the display processing portion causes both information on a related user whose relationship with the first user is of the standard friend type and information on a related user whose relationship with the first user is of the unrequited friend type to be displayed; and
the second display processing portion causes information on the first user to be displayed in the terminal apparatus of the related user where the type of the relationship with the related user is the standard friend type, but does not cause the information on the first user to be displayed in the terminal apparatus of the related user where the type of the relationship with the related user is the unrequited friend type.

5. The virtual social group management system according to claim 1, further comprising:
a second display processing portion that causes information on the first user to be displayed in a terminal apparatus of the related user,
wherein the relationship type storage portion stores at least one of a standard friend type and a pseudo-withdrawn type as the type of the relationship for each of the related users; and
the second display processing portion causes information on the first user to be displayed in the terminal apparatus of the related user where the type of the relationship with the related user is the standard friend type, but does not cause the information on the first user to be displayed in the terminal apparatus of the related user where the type of the relationship with the related user is the pseudo-withdrawn type.

6. The virtual social group management system according to claim 1,
wherein the relationship type storage portion stores at least one of a close friend type, a standard friend type, and a trial type as the type of the relationship for each of the related users;
the display processing portion causes information on a related user whose relationship with the first user is of the close friend type to be displayed preferentially to information on a related user whose relationship with the first user is of the standard friend type and information on a related user whose relationship with the first user is of the trial type, and does not cause the information on the related user whose relationship with the first user is of the trial type to be displayed when a predetermined amount of time has passed since the relationship with the first user was established as the trial type; and
where no less than a predetermined number of events have occurred between the first user and a related user, the relationship type storage portion changes the type of the relationship between the first user and the related user from the trial type to the standard friend type, or from the standard friend type to the close friend type, and stores that type.

7. The virtual social group management system according to claim 1,
wherein the relationship type storage portion stores at least one of a close friend type, a standard friend type, and a trial type as the type of the relationship for each of the related users;
the display processing portion causes information on a related user whose relationship with the first user is of the close friend type to be displayed preferentially to information on a related user whose relationship with the first user is of the standard friend type and information on a related user whose relationship with the first user is of the trial type, and does not cause the information on the related user whose relationship with the first user is of the trial type to be displayed when a predetermined amount of time has passed since the relationship with the first user was established as the trial type; and
where less than a predetermined number of events have occurred between the first user and a related user, the relationship type storage portion changes the type of the relationship between the first user and the related user from the close friend type to the standard friend type and stores that type.

8. A virtual social group management system that is provided with a portion providing a friend service and that manages a virtual social group for a first user and one or more second users to interact with one another via a communication line, the system comprising:
a recommended user storage portion that stores a recommended user that is one of the second users that has been recommended by a third user;
a friend storage portion that stores a combination Of users that have a friend relationship; and
a friend registration processing portion that causes a combination of the recommended user stored in the recommended user storage portion and the first user to be stored in the friend storage portion when the first user has received an invitation from the third user and has joined the virtual social group.

9. A virtual social group management method that manages a virtual social group for a first user and one or more second users to interact with one another via a communication line, the method comprising:
storing a type of a relationship for each related user in a relationship type storage portion, the related user being one of the second users that has a relationship with the first user; and
causing information on the related users to be displayed in a terminal apparatus of the first user based on the type of the relationship between each of the related users and the first user stored in the relationship type storage portion.

10. A computer-readable recording medium storing a computer program for controlling a computer that manages a virtual social group for a first user and one or more second users to interact with one another via a communication line, the program causing the computer to execute:
a process for storing a type of a relationship for each related user in a relationship type storage portion, the related user being one of the second users that has a relationship with the first user; and
a process for causing information on the related users to be displayed in a terminal apparatus of the first user based on the type of the relationship between each of the related users and the first user stored in the relationship type storage portion.
